(19) United States
(12) Patent Application Publication
(10) Pub. No.: US 2021/0245459 A1
(43) Pub. Date: Aug. 12, 2021

(54) SEALING COMPOUNDS FOR SELF-SEALING TYRES

(71) Applicant: ARLANXEO DEUTSCHLAND GMBH, Dormagen (DE)

(72) Inventors: Jiawen ZHOU, Moers (DE); Goran STOJCEVIC, Düsseldorf (DE)

(21) Appl. No.: 16/973,593

(22) PCT Filed: Jun. 12, 2019
(86) PCT No.: PCT/EP2019/065332

§ 371 Date: Dec. 9, 2020

(30) Foreign Application Priority Data
Jun. 13, 2018 (EP) 18177546.1

(51) Int. Cl. B29C 73/16; B29D 30/06; C08L 23/22; C08K 5/00; C08K 3/013; C08L 9/06; C08L 9/02; C08K 5/3437

(52) U.S. Cl. CPC B29C 73/163; B29D 30/0685; C08L 23/22; C08K 5/3437; C08K 3/013; C08L 9/06; C08L 9/02; C08K 5/0016

(57) ABSTRACT

The present invention relates to a sealing compound, in particular a tyre sealing compound, comprising a specific crosslinked butyl rubber and the use thereof as well as a process for producing said sealing compound.

The present invention relates to a sealing compound, in particular a tyre sealing compound, comprising a specific crosslinked butyl rubber and the use thereof as well as a process for producing said sealing compound.

In the operation of a pneumatic tyre for cars and trucks, there is the risk of damage to the tyre as a result of the penetration of foreign bodies and of the tyre losing air because of the damage. The loss of tyre air often leads to an unstable ride state which requires the immediate changing of or a makeshift repair to the tyre. In order not to have to stop and leave the vehicle for a tyre change or repair in hazardous traffic situations, various tyre and wheel designs have been developed. Thus, there exist on the market tyres having runflat properties which enable temporary continuation of the journey by lowering the tread onto a support ring beneath in the event of loss of tyre pressure. In addition, there are runflat tyres which feature a reinforced tyre sidewall which, in the event of loss of tyre pressure, can bear the axle load even without air pressure for a limited period, without getting into an unsafe ride situation. All these designs that are present on the market increase the weight of the tyre and the rolling resistance significantly, and hence the consumption of fuel in motor vehicle operation.

Tyres having a sealing compound in the form of a self-sealing layer which surrounds penetrating foreign bodies and/or directly closes the holes that they form are known in principle.

U.S. Pat. No. 3,565,151 discloses a self-sealing tyre containing two plies of sealing compounds which are separated by the inner liner and are supported from bead to bead within the tyre carcass. The sealing material consists mainly of styrene-butadiene rubber (SBR) and a small amount of crosslinkers, wherein the SBR component is a mixture of 80 phr to 95 phr (parts per hundred rubber) of cold-polymerized SBR and 5 phr to 20 phr of hot-polymerized SBR. The document does not give any pointer at all to adhesion and cohesion properties.

Self-sealing tyres are also disclosed in U.S. Pat. No. 3,981,342. The patent describes a self-sealing tyre having a layer including a mixture of a low molecular weight liquid elastomer and a high molecular weight solid elastomer, and an amount of crosslinking agent sufficient to produce partial crosslinking of the mixture, the liquid elastomer being present in a greater amount than the solid elastomer.

U.S. Pat. No. 4,228,839 discloses a self-sealing tyre having a layer including a mixture of a polymeric material degradable by high-energy radiation and a polymeric material crosslinkable by radiation and/or by heat.

U.S. Pat. No. 4,664,168 discloses a self-sealing tyre having a self-sealing layer on the inside and a multitude of support elements which partly overlap with the sealing layer, in order to keep the sealing compound in place during production and use.

U.S. Pat. No. 7,004,217 discloses a self-sealing tyre comprising a sealing chamber having a sealing compound between the carcass and the inner liner.

U.S. Pat. No. 4,113,799 discloses a sealing layer comprising a butyl rubber of high molecular weight and a butyl rubber of low molecular weight in a ratio of 20:80 to 60:40, with addition of tackifiers in an amount of 55% by weight to 70% by weight.

DE-A-10-2009-003333 discloses sealing compounds composed of viscoelastic gel for self-sealing pneumatic motor vehicle tyres, comprising a filler composed of polymers such as unvulcanized or vulcanized rubber in the form of particles having a mean diameter of 0.05 mm to 8 mm. The particles are intended to further improve the sealing action compared to known sealants composed of gel. The effects on the adhesion and cohesion properties are undisclosed.

WO-A-2008/019901 discloses, inter alia, sealing compounds based on butyl rubber that was partially crosslinked with p-quinone dioxime and benzoylperoxide.

Further, U.S. Pat. No. 5,295,525 discloses sealants based on rubbers and on a combination of liquid rubber types of low molecular weight and solid rubber types of high molecular weight.

The gel systems detailed in U.S. Pat. No. 6,508,898 are based on polyurethane and silicone. However, vulcanizates made from silicone rubber lack resistance to naphthenic and aromatic oils, for example. Low adhesion to other substrates (low surface energy) and high water vapour and gas permeability are likewise disadvantageous for use for tyres. It has been stated that silicone rubber has a gas permeability 100 times higher than BR or natural rubber (Kautschuk Technologie [Rubber Technology], F. Röthemeyer, F. Sommer, Carl Hanser Verlag Munich Vienna, 2006; page 206). A disadvantage of the use of polyurethane rubbers is their lack of compatibility with plasticizers. Phthalic and adipic esters are compatible at up to 30 phr. Polyester types require hydrolysis stabilizers; polyether types require UV stabilizers. Polyurethane elastomers that are to be found in the upper region of the hardness scale also have unfavourable heat resistance because of their propensity to hydrolysis (Kautschuk Technologie, F. Röthemeyer, F. Sommer, Carl Hanser Verlag Munich Vienna, 2006; page 218). For the reasons mentioned above, therefore, use of sealants for silicone rubber- and polyurethane rubber-based tyre applications is disadvantageous.

WO-A-2009/143895 discloses sealing compounds comprising precrosslinked SBR particles as a secondary component and natural or synthetic rubber as a main component. These crosslinked SBR particles are produced by hot emulsion polymerization. Various studies show that the reduction in the polymerization temperature from 50° C. in the case of hot emulsion polymerization to 5° C. in the case of cold emulsion polymerization had a strong influence on the molecular weight distribution. The formation of low molecular weight fractions in the rapid reaction of the thiols in the initial phase of the free-radical polymerization at 5° C. was distinctly reduced, and so better control of the chain length of the polymers was enabled. It was shown that, as well as the improved chain length distribution, the unwanted and uncontrolled crosslinking reaction was also distinctly reduced. The SBR particles obtained by hot emulsion polymerization therefore have, compared to cold polymers, a very broad molecular weight distribution and a high level of uncontrolled branching. Controlled adjustment of the viscoelastic properties is therefore impossible (Science and Technology of Rubber, James E. Mark, Burak Erman, Elsevier Academic Press, 2005, page 50).

Self-sealing tyres with a sealant layer comprising an ionomer produced from a halobutyl rubber and a nitrogen or phosphorous containing nucleophile is known from EP 2 993 061 A.

Self-sealing tires with a built-in puncture sealant layer comprising, for example, organoperoxide depolymerized butyl rubber joined together to form a unitary sealant layer is disclosed in EP 2 939 823 A1.

WO-A-2017/017080 discloses sealing compounds comprising sealing gels having a Mooney viscosity (ML1+4@100° C.) in the range from 100 MU to 170 MU which are inter alia obtainable by emulsion polymerization of at least one conjugated diene in the presence of at least one crosslinker and diene rubber gel, having a Mooney viscosity (ML1+4) @ 100° C. of 75 MU to 110 MU under certain process conditions.

Viscoelasticity is a characteristic of the material in the sense that, as well as features of pure elasticity, features of viscous fluidity are also present, which is manifested, for example, in the occurrence of internal friction on deformation.

The resulting hysteresis is typically characterized by the measurement of the loss factor tan δ at high temperature (e.g. 60° C.) and is a key parameter for rubber mixtures in tyres, especially for tyre treads. The hysteresis is not just an indicator of the heat build up in rubber mixtures under dynamic stress (reversible elongation) but also a good indicator of the rolling resistance of a tyre (Rubber Technologist's Handbook, Volume 2; page 190). A measurement parameter for hysteresis losses is the tan δ, which is defined as the ratio of loss modulus to storage modulus; cf., for example, also DIN 53 513, DIN 53 535. Commercially available sealing compounds, for example ContiSeal® from Continental, have a comparatively high tan δ value at 60° C., 10 Hz and a heating rate of 3 K/min of 0.58.

The lowering of tan δ in the temperature/frequency range and amplitude range of application-related relevance leads, for example, to reduced heat buildup in the elastomer. Minimum rolling resistance of the tyres enables minimum fuel consumption of the vehicle equipped therewith.

Rolling resistance is understood to mean the conversion of mechanical energy to heat by the rotating tyre per unit length. The dimension of rolling resistance is joules per metre (Scale Models in Engineering, D. Schuring, Pergamon Press, Oxford, 1977).

The sealing compounds have to meet high demands in practical use. They have to be soft, tacky and dimensionally stable over the entire range of operating temperatures from −40° C. to +90° C. At the same time, the sealing compounds also have to be viscous.

Following entry of an object through the tyre tread into the interior of the tyre, the sealing compound should enclose the object. If the object exits from the tyre, the sealing compound sticking to the object is drawn into the resulting hole or the sealing compound flows into the hole as a result of the internal tyre pressure and closes the hole. In addition, these sealing compounds have to be impervious to gas, such that temporary further travel is enabled. The sealing compound should be applicable to the inner tyre liner in a simple process.

The sealing compounds additionally have to have high adhesion to the inner liner, and high cohesion in order to remain dimensionally stable within the tyre.

The prior art shows that the known sealing compounds are still not satisfactory for particular applications in which not only a minimum rolling resistance but also simultaneously excellent adhesion and cohesion properties are necessary.

### SUMMARY OF THE INVENTION

The present invention comprises sealing compounds in particular for self-sealing tyres, which fulfil the high demands in practical use, especially in terms of adhesion and cohesion properties.

The sealing compounds according to the present invention exhibit excellent adhesion and cohesion while only causing a very low deterioration of rolling resistance when used in self-sealing tyres, the latter also being part of the present invention.

### DETAILED DESCRIPTION OF THE INVENTION

In particular, the invention comprises in particular a sealing composition comprising

(A) at least one crosslinked butyl rubber

(B) at least one resin

and optionally one, two, three or all of the following components:

(C) at least one ageing stabilizer

(D) at least one rubber other than the crosslinked butyl rubbers according to (A)

(E) at least one plasticizer

(F) at least one filler

It should be noted at this point that the scope of the invention includes any and all possible combinations of the components, ranges of values and/or process parameters mentioned above and cited hereinafter, in general terms or within areas of preference.

The sealing compounds comprise at least one cross-linked buyl rubber (A).

As used herein the term crosslinked butyl rubber denotes copolymers comprising structural units derived from
a) at least one isoolefin
b) at least one conjugated multiolefin wherein the structural units derived from conjugated multiolefin may be either (i) at least partially halogenated or (ii) non-halogenated and
c) optionally but preferably at least one crosslinking multiolefin other than the conjugated multiolefins according to b)

whereby the crosslinked butyl rubbers further have

a Mooney viscosity of at least 30 measured according to ASTM D 1646, ML 1+8 at 125° C., preferably of from 30 to 120 more preferably of from 40 to 100, more preferably of from 55 to 100 and even more preferably of from 55 to 90 and

II) a gel content of a least 5 wt-%, preferably 5 to 60 wt-%, more preferably 7 to 55 wt-% and most preferably 10 to 50 wt-%.

To determine the gel content, 250 mg of the crosslinked butyl rubber are swollen under agitation in 25 ml of toluene at 23° C. for 24 h. The resulting gel is centrifuged off at 20 000 rpm for 120 minutes, separated, dried to constant weight at 70° C. and weighed. The gel content is calculated as follows:

Gel content=dry weight of the gel in mg/250 mg.

The total amount of crosslinked butyl rubber in the sealing compound according to the invention is typically 45 phr to 100 phr, preferably 60 phr to 100 phr, more preferably 70 phr to 100 phr, with the sum of crosslinked butyl rubber (A) and, where present, further rubbers (D) representing 100 phr.

If not expressly stated otherwise phr refers to parts per hundred rubber.

The present invention is not restricted to a special process for preparing the crosslinked butyl rubbers. The preparation of crosslinked butyl rubbers is well known to those skilled in the art and may be performed for example by (A) modifying standard isoprene-isobutylene rubbers (IIR) or their halogenated analogues (CIIR, BIIR) by peroxide or temperature induced reaction with crosslinkers in particular those mentioned above or by (B) copolymerizing isoolefins, conjugated multiolefins and crosslinking multiolefins in particular those mentioned above according to standard procedures.

Preferably, the polymerization is conducted at a temperature conventional in the production of butyl polymers—e.g., in the range of from −100° C. to +50° C. The polymer may be produced by polymerization of a monomer mixture in solution or by a slurry polymerization method. Polymerization is preferably conducted in suspension (the slurry method)—see, for example, Ullmann's Encyclopedia of Industrial Chemistry (Fifth, Completely Revised Edition, Volume A23; Editors Elvers et al., 290-292).

Preferably, the monomer mixture to be polymerized comprises in the range of from 75% to 99.98% by weight of at least one isoolefin, in the range of from 0.01% to 15% by weight of at least one conjugated multiolefin, and in the range of from 0.01% to 10% by weight of at least one crosslinking multiolefin.

More preferably, the monomer mixture comprises in the range of from 82% to 99.9% by weight of a C₄ to C₇ isoolefin, in the range of from 0.05% to 10% by weight of at least one conjugated multiolefin, and in the range of from 0.05% to 8% by weight of at least one crosslinking multiolefin.

Most preferably, the monomer mixture comprises in the range of from 95% to 99.85% by weight of a C₄ to C₇ isoolefin, in the range of from 0.1% to 5% by weight of at least one conjugated multiolefin, and in the range of from 0.05% to 5% by weight of at least one crosslinking multiolefin. It will be apparent to the skilled in the art that the total of all monomers will result in 100% by weight.

The monomer mixture may contain minor amounts of one or more additional polymerizable co-monomers. For example, the monomer mixture may contain a small amount of a styrenic monomer like p-methylstyrene, styrene, α-methylstyrene, p-chlorostyrene, p-methoxystyrene, indene (including indene derivatives) and mixtures thereof. If present, it is preferred to use the styrenic monomer in an amount of up to 5.0% by weight of the monomer mixture. The values of the isoolefin will have to be adjusted accordingly to result again in a total of 100% by weight.

Examples of suitable isoolefins include isoolefin monomers having from 4 to 16 carbon atoms, preferably 4 to 7 carbon atoms, such as isobutene, 2-methyl-1-butene, 3-methyl-1-butene, 2-methyl-2-butene. The most preferred isoolefin is isobutene.

Examples of suitable conjugated multiolefins include isoprene, butadiene, 2-methylbutadiene, 2,4-dimethylbutadiene, piperyline, 3-methyl-1, 3-pentadiene, 2,4-hexadiene, 2-neopentylbutadiene, 2-methyl-1, 5-hexadiene, 2,5-dimethyl-2, 4-hexadiene, 2-methyl-1,4-pentadiene, 4-butyl-1, 3-pentadiene, 2,3-dimethyl-1, 3-pentadiene, 2,3-dibutyl-1, 3-pentadiene, 2-ethyl-1, 3-pentadiene, 2-ethyl-1, 3-butadiene, 2-methyl-1, 6-heptadiene, cyclopentadiene, methylcyclopentadiene, cyclohexadiene and 1-vinyl-cyclohexadiene, 1-methylcycloheptene.

Preferred conjugated multiolefins are isoprene and butadiene. Isoprene is particularly preferred.

Crosslinking multiolefins other than conjugated multiolefins include norbornadiene, 2-isopropenylnorbornene, 5-vinyl-2-norbornene, divinylbenzene, diisopropenylbenzene, divinyltoluene, divinylxylene or C₁ to C₂₀ alkyl-substituted derivatives of the above compounds. More preferably, the crosslinking multiolefin is divinylbenzene, diisopropenylbenzene, divinyltoluene, divinylxylene or C₁ to C₂₀ alkyl substituted derivatives of said compounds. Most preferably the crosslinking multiolefin is divinylbenzene or diisopropenylbenzene.

The content of structural units derived from conjugated multiolefins of the crosslinked butyl rubbers employed for the compounds according to the invention is typically 0.1 mol-% or more, preferably of from 0.1 mol-% to 15 mol-%, in another embodiment 0.5 mol-% or more, preferably of from 0.5 mol-% to 10 mol-%, in another embodiment 0.7 mol-% or more, preferably of from 0.7 to 8.5 mol-% in particular of from 0.8 to 1.5 or from 1.5 to 2.5 mol-% or of from 2.5 to 4.5 mol-% or from 4.5 to 8.5 mol-%, particularly where isobutene and isoprene are employed.

For crosslinked butyl rubbers comprising structural units derived from conjugated multiolefins which are at least partially halogenated the halogen level is for example of from 0.1 to 5 wt.-%, preferably of from 0.5 to 3.0 wt.-% with respect to the crosslinked butyl rubber.

The halogenated shall preferably mean chlornated or brominated In one embodiment of the invention, the copolymer is isobutylene-isoprene-rubber (IIR, butyl rubber), bromobutyl rubber (BIIR) or chlorobutyl rubber (CIIR).

The term “content” given in mol-% denotes the molar amount of structural units derived from the respective monomer in relation to all structural units of the crosslinked butyl rubber.

The sealing compounds further comprise at least one resin (B).

Examples of useful resins include hydrocarbon resins. Hydrocarbon resins are understood by those skilled in the art to mean compounds based on carbon and hydrogen which are used typically used as tackifiers in polymer mixtures. They are miscible or at least compatible with the polymer mixture in the amount used and act as diluents and/or extenders in the mixture. The hydrocarbons resins may be solid or liquid. The hydrocarbon resins may contain aliphatic, cycloaliphatic, aromatic and/or hydrogenated aromatic compounds. Different synthetic and/or natural resins may be used and may be oil-based (mineral oil resins). The Tg of the resins used should be above −50° C., preferably between −50° C. and 100° C. The hydrocarbon resins may also be described as thermoplastic resins which soften and can thus be formed when heated. They may be characterized by the softening point or that temperature at which the resin sticks together, for example in the form of granules.

Preferred resins exhibit at least one and more preferably all of the following properties:
Tg greater than −50° C.,
softening point greater than −30° C. (especially in the range from −30° C. to 135° C.),
the number-average molecular weight (Mn) is in the range from 400 g/mol to 2000 g/mol,
the polydispersity (PDI=Mw/Mn, with Mw=weight-average molecular weight) is less than 3.

The softening point is determined by the “Ring and Ball” method of standard ISO 4625. Mn and Mw can be determined by means of techniques familiar to those skilled in the art, for example gel permeation chromatography (GPC).

Examples of the hydrocarbon resins used are cyclopentadiene (CPD) or dicyclopentadiene (DCPD) homopolymer or cyclopentadiene copolymer resins, terpene homopolymer or copolymer resins, terpene/phenol homopolymer or copolymer resins, homopolymer or copolymer resins of the C₅ fraction or C₉ fraction, homo- or copolymer resins of α-methylstyrene and mixtures of those described. Particular mention should be made here of the copolymer resins consisting of (D)CPD/vinylaromatic copolymer resins, (D)CPD/terpene copolymer resins, (D)CPD/C₅fraction copolymer resins, (D)CPD/C₉ fraction copolymer resins, terpene/vinylaromatic copolymer resins, terpene/phenol copolymer resins, C₅ fraction/vinylaromatic copolymer resins and mixtures of those described.

The term “terpene” encompasses monomers based on α-pinene, β-pinene and limonene, preference being given to limonene or a mixture of the limonene enantiomers. Suitable vinylaromatics are, for example, styrene, α-methylstyrene, o-methylstyrene, m-methylstyrene, p-methylstyrene, vinyltoluene, p-(tert-butyl)styrene, methoxystyrene, chlorostyrene, hydroxystyrene, vinylmesitylene, divinylbenzene, vinyl naphthalene or any vinylaromatic from the C₉ fraction or from the C₈ to C₁₀ fraction.

The amount of resin (B) in the sealing compound of the invention is typically 10 phr to 60 phr, preferably 20 phr to 55 phr, more preferably 25 phr to 50 phr based on the sum of crosslinked butyl rubber and, where present further rubbers (D).

The sealing compounds may further comprise at least one ageing stabilizer (C).

Suitable ageing stabilizers include phenolic ageing stabilizers such as alkylated phenols, styrenated phenol, sterically hindered phenols such as 2,6-di-tert-butylphenol, 2,6-di-tert-butyl-p-cresol (BHT), 2,6-di-tert-butyl-4-ethylphenol, sterically hindered phenols containing ester groups, sterically hindered phenols containing thioether groups, 2,2′-methylenebis-(4-methyl-6-tert-butylphenol) (BPH), and also sterically hindered thiobisphenols.

If discolouration of the rubber is less important, aminic ageing stabilizers may also be used, for example mixtures of diaryl-p-phenylenediamines (DTPD), octylated diphenylamine (ODPA), phenyl-α-naphthylamine (PAN), phenyl-β-naphthylamine (PBN), preferably those based on phenylenediamine. Examples of phenylenediamines are N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis-1,4-(1,4-dimethylpentyl)-p-phenylenediamine (77PD), etc.

Other ageing stabilizers include phosphites such as tris(nonylphenyl) phosphite, polymerized 2,2,4-trimethyl-1,2-dihydroquinoline (TMQ), 2-mercaptobenzimidazole (MBI), methyl-2-mercaptobenzimidazole (MMBI), zinc methylmercaptobenzimidazole (ZMMBI). The phosphites may be used in combination with phenolic ageing stabilizers.

The amount of ageing stabilizer (C) in the sealing compound is typically 0.5 phr to 20 phr, preferably 1 phr to 10 phr, more preferably 1 phr to 7 phr, based on the sum of crosslinked butyl rubber and, where present, further rubbers (D).

The sealing compounds may further comprise at least one rubber other than the crosslinked butyl rubbers according to component (A)

Suitable rubbers (D) include copolymers based on conjugated diolefins from a group comprising 1,3-butadiene, isoprene, 2,3-dimethyl-1,3-butadiene, 1,3-pentadiene, 1,3-hexadiene, 3-butyl-1,3-octadiene, 2-phenyl-1,3-butadiene or mixtures thereof, more preferably from a group comprising natural cis-1,4-polyisoprene, synthetic cis-1,4-polyisoprene, 3,4-polyisoprene, polybutadiene, 1,3-butadiene-acrylonitrile copolymer and mixtures thereof.

Such rubbers are described, for example, in I. Franta, Elastomers and Rubber Compounding Materials, Elsevier, New York 1989, or else in Ullmann's Encyclopedia of Industrial Chemistry, Vol. A 23, VCH Verlagsgesellschaft, Weinheim 1993 and include
BR—polybutadiene,
Nd-BR—neodymium polybutadiene rubber,
Co-BR—cobalt polybutadiene rubber,
Li-BR—lithium polybutadiene rubber,
Ni-BR—nickel polybutadiene rubber,
Ti-BR—titanium polybutadiene rubber,
PIB—polyisobutylene,
ABR—butadiene/C₁₋₄-alkyl acrylate copolymers,
IR—polyisoprene,
SBR—styrene/butadiene copolymers having styrene contents of 1% by weight to 60% by weight, preferably 2% by weight to 50% by weight,
E-SBR—emulsion styrene/butadiene copolymers,
S-SBR—solution styrene/butadiene copolymers,
XSBR—styrene/butadiene copolymers and graft polymers with acrylic acid, methacrylic acid, acrylonitrile, hydroxyethyl acrylate and/or hydroxyethyl methacrylate, glycidyl methacrylate having styrene contents of 2% by weight to 50% by weight and contents of copolymerized polar monomers of 1% by weight to 30% by weight,
NBR—butadiene/acrylonitrile copolymers, typically having acrylonitrile contents of 5% by weight to 60% by weight, preferably 10% by weight to 50% by weight,
HNBR—fully and partly hydrogenated NBR rubber in which up to 100% of the double bonds are hydrogenated,
HXNBR—carboxylated partly and fully hydrogenated nitrile rubbers,
EP(D)M—ethylene/propylene/(diene) copolymers,
EVM—ethylene-vinyl acetate,
and optionally, to the extent they do not fulfil the definition given above for crosslinked butyl rubbers
IIR—isobutylene/isoprene copolymers, preferably having isoprene contents of 0.5% by weight to 10% by weight,
BIIR—brominated isobutylene/isoprene copolymers, preferably having bromine content 0.1% by weight to 10% by weight,
CIIR—chlorinated isobutylene/isoprene copolymers, preferably having chlorine content 0.1% by weight to 10% by weight,
and mixtures of all of these aforementioned rubbers.

The amount of rubber (D) in sealing compounds of the invention is typically 0 phr to 55 phr, preferably 0 phr to 40 phr, more preferably 0 phr to 30 phr, based on the sum of crosslinked butyl rubber and further rubbers (D).

The sealing compounds may further comprise at least one plasticizer.

Platicizers dilute the matrix comprising the rubbers and resins and makes it softer and more supple, in order to improve the sealing effect of the sealing mixture under cold conditions in particular at temperatures below 0° C. Suitable plasticizers typically have a Tg of less than −20° C. and preferably less than −40° C.

Suitable plasticizers are any liquid elastomers or lubricant oils, which may be either aromatic or nonaromatic, and any liquid substances which are known for their plasticizing action in elastomers, especially in diene-containing elastomers. Particularly suitable are liquid elastomers having an Mn of 400 to 90 000 g/mol. Examples of lubricant oils are paraffinic oils, naphthenic oils having low or high viscosity, in hydrogenated or non-hydrogenated form, aromatic or DAE (Distilled Aromatic Extracts) oils, MES (Medium Extracted Solvates) oils, TDAE (Treated Distillate Aromatic Extracts) oils, mineral oils, vegetable oils (and oligomers thereof, for example palm oil, rapeseed oil, soya oil or sunflower oil) and mixtures of the oils mentioned.

Also suitable are oils based on polybutene, especially polyisobutylene (PIB)-based oils, and ether-, ester-, phosphate- and sulphonate-based plasticizers, preference being given to esters and phosphates. Preferred phosphate plasticizers are those having 12 to 30 carbon atoms, for example trioctyl phosphate. Preferred ester plasticizers are substances from the group comprising trimellitates, pyromellitates, phthalates, 1,2-cyclohexanedicarboxylates, adipates, azelates, sebacates, glycerol triesters and mixtures thereof. The fatty acids used with preference, in synthetic or natural form (in the case of sunflower oil or rapeseed oil, for example), are those containing more than 50% by weight and more preferably more than 80% by weight of oleic acid. Among the triesters, preference is given to glycerol triesters consisting predominantly to an extent of more than 50% by weight, more preferably more than 80% by weight, of unsaturated C₁₈ fatty acids, for example oleic acid, linoleic acid, linolenic acid and mixtures thereof. Such triesters have a high content of oleic acid and are described in the literature as plasticizers for rubber mixtures which are used in tyre treads, for example in US-A-2004/0127617.

Unlike in the case of liquid elastomers, the number-average molecular weight (Mn) of the liquid plasticizer is preferably in the range from 400 to 25 000 g/mol, even more preferably in the range from 800 to 10 000 g/mol (measured by means of GPC).

In summary, preference is given to using liquid plasticizers from the group of the liquid elastomers, polyolefin oils, naphthene oils, paraffin oils, DAE oils, MES oils, TDAE oils, mineral oils, vegetable oils, plasticizers composed of ethers, esters, phosphates, sulphonates and mixtures of those described.

The amount of plasticizer (E) in the sealing compounds of the invention may be for example 0 phr to 60 phr, preferably 10 phr to 55 phr, more preferably 15 phr to 50 phr, based on the sum of crosslinked butyl rubber and, where present, further rubbers (D).

The sealing compounds may further comprise at least one filler.

As used herein the term filler includes reinforcing fillers (typically particles having an average size of less than 500 nm, especially in the range from 20 nm to 200 nm) and non-reinforcing or inert fillers (typically particles having an average size of more than 1 μm, for example in the range from 2 μm to 200 μm). The reinforcing and non-reinforcing fillers are intended to improve cohesion in the sealing compound.

Suitable fillers include:
carbon blacks typically used in tyre production, for example carbon blacks according to ASTM Standard 300, 600, 700 or 900 (N326, N330, N347, N375, N683, N772 or N990), and typically produced by the thermal black, furnace black or gas black method and having BET surface areas of 20 m²/g to 200 m²/g (determined by means of absorption of CTAB as described in ISO 6810 Standard), for example SAF, ISAF, IISAF, HAF, FEF or GPF carbon blacks. Alternatively, it is also possible to use carbon blacks having a surface area of less than 20 m²/g.
silicas, for example those produced by precipitation of solutions of silicates or flame hydrolysis of silicon halides having specific surface areas of 5 to 1000 and preferably 30 m²/g to 400 m²/g (BET surface area measured by the ISO 5794/1 Standard) and having primary particle sizes of 5 to 400 nm. The silicas may optionally also be in the form of mixed oxides with other metal oxides, such as oxides of Al, Mg, Ca, Ba, Zn and Ti.
synthetic silicates, such as aluminium silicate, alkaline earth metal silicates such as magnesium silicate or calcium silicate, having BET surface areas (measured by the ISO 5794/1 Standard) of 20 m²/g to 400 m²/g and primary particle diameters of 10 nm to 400 nm.
natural silicates, such as kaolin and other naturally occurring silicas.
metal oxides, such as zinc oxide, calcium oxide, magnesium oxide, aluminium oxide.
metal carbonates, such as magnesium carbonate, calcium carbonate, zinc carbonate.
metal sulphates, such as calcium sulphate, barium sulphate.
metal hydroxides, such as aluminium hydroxide and magnesium hydroxide.
colouring fillers or coloured fillers, such as pigments.
rubber gels based on polychloroprene, NBR and/or polybutadiene having particle sizes of 5 nm to 1000 nm.

The aforementioned fillers can be used alone or in combination.

The fillers may be present in the sealing compounds according to the invention in an amount of 1 phr to 50 phr, preferably in an amount of 1 phr to 35 phr, more preferably in an amount of 1 phr to 30 phr, based on the sum of crosslinked butyl rubber and, where present, further rubbers (D).

The sealing compounds according to the invention may additionally comprise further components.

Such further components include rubber auxiliaries typically used in rubber mixtures, for example one or more further crosslinkers, accelerators, thermal stabilizers, light stabilizers, ozone stabilizers, processing aids, extenders, organic acids or retardants.

The further rubber auxiliaries can be used alone or in combination.

The rubber auxiliaries may used in amounts of 0.1 phr to 50 phr in total.

In one embodiment of the invention, the sealing compound comprises
45 phr to 100 phr, preferably 60 phr to 100 phr and more preferably 70 phr to 100 phr of at least one crosslinked butyl rubber
10 phr to 60 phr, preferably 20 phr to 55 phr and more preferably 25 phr to 50 phr of at least one resin (B),
0 phr to 20 phr, preferably 1 phr to 10 phr and more preferably 1 phr to 7 phr of at least one ageing stabilizer (C),
0 phr to 55 phr, preferably 0 phr to 40 phr and more preferably 0 phr to 30 phr of at least one rubber (D),
0 phr to 60 phr, preferably 10 phr to 55 phr and more preferably 15 phr to 50 phr of at least one plasticizer (E),
optionally 1 phr to 50 phr, preferably 1 phr to 35 phr and more preferably 1 phr to 30 phr of at least one filler (F),
   based in each case on the sum of crosslinked butyl rubber (A) and, where present, further rubbers (D).

In one embodiment of the invention the sealing compound according to the invention further exhibits at least one of the properties described hereinafter:

The sealing compound of the invention for example has a Mooney viscosity (ML1+4©100° C.) of 5 MU up to 50 MU, preferably 6 MU up to 20 MU. The Mooney viscosity is determined by the standard ASTM D1646 (1999) and measures the torque of the sample at elevated temperature. It has been found to be useful to calender the sealing compound beforehand. For this purpose, the sealing compound is processed on a roller at a roller temperature of T≤60° C. to give a rolled sheet. The cylindrical sample punched out is placed into the heating chamber and heated up to the desired temperature. After a preheating time of one minute, the rotor rotates at a constant 2 revolutions/minute and the torque is measured after four minutes. The Mooney viscosity measured (ML 1+4) is in “Mooney units” (MU, with 100 MU=8.3 Nm).

For the sealing compound of the invention for example the distance that the steel ball covers in the rolling ball tack test is typically less than 3 cm, more preferably less than 2 cm, most preferably in the range from 0.05 cm to 2.0 cm.

The sealing compound should exert a minimum influence on the rolling resistance of the tyre. For this purpose, the loss factor tan δ at 60° C., which is established in industry as a rolling resistance indicator, is employed as the measurement parameter, this being determined by dynamic-mechanical analysis (DMA) with a rheometer. From the measurement, the temperature-dependent storage and loss moduli G′ and G″ are obtained. The temperature-dependent tan δ value is calculated from the quotient of loss modulus to storage modulus. The tan δ value at 60° C. and 10 Hz for the sealing compounds of the invention is typically less than 0.35, preferably less than 0.30 and more preferably less than 0.25.

The sealing compounds according to the invention may be produced by all methods known to those skilled in the art. For example, it is possible to mix the solid or liquid individual components. Examples of equipment suitable for the purpose are rollers, internal mixers or mixing extruders. For example, in a first step, the at least one crosslinked butyl rubber is mixed with at least one resin (B) at a temperature (1st mixing temperature) which is above the softening temperature of the resin. It should be noted here that the temperature is not the target temperature for the mixer but the actual temperature of the mixture followed by further components, if any. Further processing steps are preferably effected at a temperature below the softening temperature of the resin (B), for example at 50° C. (2nd mixing temperature).

Alternatively the production of the sealing compound may be performed as a masterbatch in a screw extruder as follows:

A single-screw extruder is used, having a 1st metered addition for the mixture constituents and a 2nd metered addition (metering pump) for the liquefied resin (B). The mixing is effected by rotating the screw, and the mixture components experience high shear. The mixture then passes to the homogenizer with a chopper tool. Downstream of this zone, the masterbatch is finally extruded in the desired shape through a simple extrusion head. The sealing mixture obtained is, for example, packed between two silicone-coated films and cooled down, and is ready to use. The extrudate can also be conducted beforehand to a twin-roller system in order to be able to meter in further mixture ingredients (pigments, fillers, etc.) if necessary in this step. The metered addition may be continuous. The roll temperature is preferably below 100° C. The sealing mixture is packed analogously. It is possible to produce this sealing mixture under industrial conditions without entering into the risk of contamination/soiling of the tools, for example as a result of sticking of the sealing compound to the roll.

The application of the sealing layer to the tyre may follow the vulcanization of the tyre. Typical methods of applying the sealing layer are described, for example, in U.S. Pat. No. 5,295,525. The sealing compounds based on diene rubber gels may be applied, for example, to the tyre lining in a continuous process without having to be subjected to a vulcanization. The sealing compound may be extruded, for example, as a sealing layer or strip on the inside of the tyre. In an alternative embodiment, the sealing compound may be processed as a strip which is then bonded to the inside of the tyre.

In a further alternative embodiment, the sealing compound can be prepared as a solvent cement which is sprayed, for example, onto the inside of the tyre. A further alternative mode of application as a laminate is described in U.S. Pat. No. 4,913,209.

The sealing compounds according to the invention are particularly useful as sealing components in self-sealing tyres, and as seals of hollow bodies and membranes.

Therefore, the invention further relates to the use of the sealing compounds in tyres, preferably as sealing layer on inner liners of pneumatic vehicle tyres.

The present invention thus further provides a pneumatic vehicle tyre comprising a sealing compound according to the invention, and a vehicle comprising at least one of such pneumatic vehicle tyres.

The advantages of the sealing compounds according to the invention are the excellent cohesion and adhesion properties and their low impact on rolling resistance of tyres.

The examples which follow describe the invention but without limiting it.

### EXAMPLES

In the examples the following substances according to Table 1 were used:

TABLE 1

| Name | Source |
|---|---|
| Buna SE 1502 H (rubber, butadiene-styrene | ARLANXEO Deutschland GmbH |
| copolymer, produced by cold emulsion | |
| polymerization, using fatty and rosin soaps as | |
| emulsifiers, Mooney ML(1 + 4 @ 100° C.) = 53, | |
| Styrene content: 23.5%, non-staining antioxidant) | |
| Nanoprene B M75OH VP (crosslinked BR rubber, | ARLANXEO Deutschland GmbH |
| glass transition temperature (Tg) = −75 ± 5° C., | |
| hydroxyl content: 30 ± 7 mg KOH/g, volatile matter = | |
| 5 ± 5 wt %) | |
| Perbunan 2831F (rubber, butadiene-acrylonitrile | ARLANXEO Deutschland GmbH |
| copolymer, Mooney ML(1 + 4 @ 100° C.) = 30 ± 5 | |
| MU, acrylonitrile content: 28.6 ± 1.0 wt %) | |
| Kalar 5280 (an unfilled crosslinked butyl rubber | Royal Elastomers |
| having a glass transition temperature of Tg = | |
| −70° C., a Mooney viscosity ML 12 + 3 @ 127° C. of | |
| 80 to 90 and a gel-content of 45%) | |
| Escorez ™ 2173 (narrow molecular weight aromatic | ExxonMobil Chemical |
| modified aliphatic hydrocarbon resin, tackifying | |
| resin, softening point = 89.7° C., Color − Initial = 70 | |
| YI, solution cloud point = −14° C., melt viscosity | |
| (160° C.) = 450 mPas, aromaticity = 12.5%) | |
| Escorez ™ 1401 (modified aliphatic hydrocarbon | ExxonMobil Chemical |
| resin with narrow molecular weight distribution, wax | |
| cloud point (EVA/resin/wax = 20/40/40) = 83° C., | |
| softening point = 119° C., Color − Initial = 30 YI, | |
| molecular weight − number average (Mn) = 1260 | |
| g/mol, glass transition temperature (Tg) = 72° C.) | |
| Novas TL10 (liquid hydrocarbon resin based on | Rutgers Novares GmbH |
| selected constituents of petroleum-derived C9-/C10 | |
| fraction, viscosity @ 25° C. = 6000-10000 mPas, | |
| acid number: max 0.5 mg KOH/g, typical color | |
| (Gardner) undiluted = 8) | |
| Nytex 8150 (plasticizer, process oil, density @ | Nynas AB |
| 15° C. = 0.919 kg/I, viscosity @ 40° C. = 150 mm²/s, | |
| viscosity @ 100° C. = 10.5 mm²/s, flash point, PM = | |
| 222° C., pour point = −24° C., volatility @ 107° C., | |
| 22 h = 0.2 wt %, Sulphur = 0.1, %, aniline point = | |
| 86° C., refractive index @ 20° C. = 1.504, viscosity- | |
| gravity-constant = 0.856, UV absorptive @ 260 nm = | |
| 4.5, total acid number < 0.01) | |
| Mesamoll (plasticizer, alkylsulphonic acid ester with | LANXESS Deutschland GmbH |
| phenol (ASE), CAS-No. 091082-17-6 (ASE), | |
| refractive index n_{D}20 = 1.499 ± 0.003, hazen color | |
| value ≤ 350, density @ 20° C. = 1.055 ± 0.015, | |
| viscosity @ 20° C. = 125 ± 15 mPas, water content | |
| max. 0.05%) | |
| Vulkanox ® HS LG (ageing stabilizer, 2,2,4- | LANXESS Deutschland GmbH |
| trimethyl-1,2-dihydroquinoline, polymerized (TMQ), | |
| softening point = 90.0 ± 5.0° C., alkalinity index = | |
| 540 ± 30) | |
| Vulkanox ® 4020/LG (ageing stabilizer, N-(1,3- | LANXESS Deutschland GmbH |
| dimethylbutyl)-N′-phenyl-p-phenylenediamine | |
| (6PPD), initial melting point ≥ 45.0° C., density @ | |
| 50° C. = 0.995 g/ml)) | |
| Tronox ® Titanium Dioxide 435 (pigment, CAS No. | Tronox Pigments (Holland) BV |
| 13463-67-7) | |
| Oppasin Blue 6900 (pigment, mixture based of Cu | BASF AG |
| phthalocyanine, polyoefine, color index: pigment | |
| blue 15: 1/74 160, color dH = ± 0.7, chroma dC = ± | |
| 0.7, dE < = 1.0, FAE = 100 ± 5, da, db, dL = ± 0.7) | |

### Test Methods

The Mooney viscosity of the crosslinked butyl rubber was determined by the standard ASTM D1646 (1999) and measures the torque of the sample at elevated temperature using a 1999 Alpha Technologies MV 2000 Mooney viscometer (manufacturer serial number: 25AIH2753).

The gel content was measured as described above in the detailed description of the invention.

The tackiness (measurement parameter for adhesion) of the sealing compound according to the invention was determined by means of a rolling ball tack tester.

The test was conducted according to standard ASTM D3121-06 at ambient temperature. The sealing compound was pressed to a thickness of 1 mm at 105° C. and 120 bar for 10 min and cooled to room temperature under pressure over a period of 12 h. The sealing compound thus pressed was cut to a rectangle of edge length 20 cm×10 cm, ensuring a smooth and contamination-free surface. The rectangular sealing compound of thickness 1 mm was placed onto a flat surface and the rolling ball tack tester was set up on the rectangular sealing film such that the tester is likewise flat (checked by means of a spirit level) and a ball rolling distance of 6 cm is possible. The polished steel ball having a diameter of 1 cm (ChemInstruments) was cleaned in acetone before each test and then placed onto the rolling ball tack tester. By actuating the trigger mechanism of the rolling ball tack tester, the ball was put in a state of controlled movement. The distance that the ball has rolled on the test material was measured. This was done by measuring from the end of the rolling ball tester to the middle of the ball. Each experiment was conducted on a contamination-free surface. The experiment was repeated at least three times and the average was reported as the result.

The determination of the loss factor tan δ at 60° C. as an indicator of rolling resistance was effected according to DIN-ISO 6721-1 and 6721-2, here using an ARES-G2 rheometer from TA Instruments. The preparation of the sealing compound for the measurement of the loss factor as an indicator of rolling resistance was conducted as follows: The sealing compound was processed on a roller at a roller temperature of T≥60° C. to give a rolled sheet. The sheet was subsequently passed through a roll gap of 0.5 mm, which resulted in a sheet having a thickness of ≤3.5 mm. A sample of size 10 cm×10 cm was taken from this sheet and pressed in a mould of 10 cm×10 cm×0.1 cm at a pressure of 120 bar and a temperature T≥105° C. for 10 min. After cooling to room temperature within 10 minutes, a round sample having a diameter of 8 mm was punched out of the pressed material for dynamic-mechanical measurements. This sample was fixed between two plates. Before the temperature run, a time run was conducted on the sample for a period of 10 min at 100° C. and an initial force of 2 N. Subsequently, a temperature run was conducted with an initial force of 2 N and maximum deformation of 2% in the range from −100° C. to 170° C. at a constant frequency of 10 Hz and a heating rate of 3 K/min.

### Example 1 and Example 2

Puncture-Sealing-Test (PST)

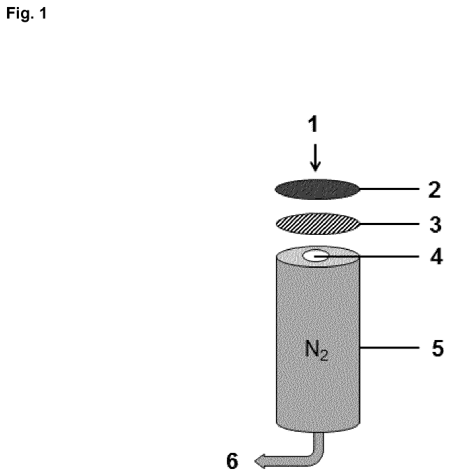

The instant sealing behaviour of the sealing compounds was determined by a puncture-sealing-test (PST) at −25° C., ambient temperature and 100° C. The test set-up was placed in a climate chamber, which can be cooled down with liquid nitrogen and heated up. The test set-up is shown in FIG. 1. And was built in a tensile machine (Zwick Z010 Retroline, BZ 010/7H2AS02, serial number: 139055, construction year 1998). It consists of a glass pressure vessel (5) simulating a tyre, which can be filled with nitrogen, a manometer connected to a computer (6) for monitoring the pressure, a tyre cross section (2) equipped with a 3 mm thick layer of the sealing compound (3). For this purpose, the sealing compound is pressed to a thickness of 3 mm at 105° C. and 120 bar for 10 min and cooled to room temperature under pressure over a period of 12 h. The pressed sealing compound which has been cut to the dimension of the tyre cross section is pressed onto the tyre section surface and positioned between the tyre cross section and the pressure vessel.

Before starting the test, the the pressure vessel (5) was filled with nitrogen reaching a pressure of 250 kPa. The pressure stayed constant over at least 12 hours. The samples with the sealing compound were conditioned at the test temperature, respectively, for at least one hour before starting the test. Puncture (1) was prepared by pressing a steel nail of 5 mm diameter with a speed of 500 mm/min into the tyre cross section (2) so that at least a length of 2.5 cm of the nail entered into the pressure vessel (5) via hole (4). After monitoring the pressure for 15 min, the nail is taken out with a speed of 500 mm/min, and again the pressure was observed for further 15 min.

The tested sealing compounds were produced on a Collin W 150 G roll mill built in April 2013. The roll temperature during the mixing operation was 90° C. The roller gap was varied between 1 mm and 3 mm, the friction was −10% and the roller revolutions per minute were 7 rpm to 8 rpm.

For the production of the sealing compound according to example 1 of the invention, the crosslinked butyl rubber (A) were first homogeneously mixed together with rubber (D). Thereafter, resin (B) was added gradually in small portions, followed by the ageing stabilizers (C), the pigment (F) and lastly the plasticizer (E).

The composition of the sealing compound according to comparison example 2 and of the sealing compound according to invention example 1 are specified in Table 2.

TABLE 2

| | | Example 2 |
|---|---|---|
| Sealing compound | Example 1 | (for comparison) |
| Nanoprene M75OH [phr] | 0 | 59.5 |
| Crosslinked butyl rubber (A) | 80 | 0 |
| Kalar 5280 | | |
| Resin (B) | 0 | 30 |
| Escorez 2173 [phr] | | |
| Resin (B) | 30 | 0 |
| Escorez 1401 [phr] | | |
| Resin (B) | 15 | 15 |
| Novares TL 10 | | |
| [phr] | | |
| Ageing stabilizer (C) | 3 | 3 |
| Vulkanox HS LG [phr] | | |
| Ageing stabilizer (C) | 3 | 3 |
| Vulkanox 4020 [phr] | | |
| Rubber (D) | 20 | 15 |
| Buna SE 1502H [phr] | | |
| Rubber (D) | 0 | 25.5 |
| Perbunan 2831 | | |
| [phr] | | |
| Plasticizer (E) | 20 | 20 |
| Mesamoll [phr] | | |
| Plasticizer (E) | 25 | 40 |
| Nytex 8150 [phr] | | |
| Pigment (F) | 1 | 1 |
| Oppasin Blue [phr] | | |
| Pigment (F) | 1 | 1 |
| Tronox [phr] | | |

The characterization of the sealing compounds is compiled in Table 3 below.

TABLE 3

| | | Example 2 |
|---|---|---|
| Sealing compound | Example 1 | (for comparison) |
| (ML1 + 4) @ 100° C. [MU] | 7 | 5 |
| Pressure loss @ −25° C. [kPa] | 0 | 0 |
| Pressure loss @ RT ° C. [kPa] | 0 | 0 |
| Pressure loss @ 100° C. [kPa] | 10 | 24 |
| tan δ @ 60° C. | 0.30 | 0.34 |
| Rolling ball tack tester [cm] | 0 | 0 |

It is apparent that the sealing compound according to the invention (example 1) is superior compared to those according to the state of the art (example 2) at typical temperatures under use i.e. rolling conditions (around 100° C.) under summer conditions.

Tyre Test:

The compounds according to examples 1 and 2 were tested in tyres.

A 3 mm thick sealant layer was applied to the inside of a cured tyre by adhesive bonding onto the inner liner in contact with the inflation air. The compound according to example 1 into tyre A and B, the compound according to example 2 was applied into tyre C and D.

During the trials, tyres of passenger vehicle type, of 215/55 R17 size, “ContiEcoContact 3 brand”, were tested. Nine perforations 3 nails with a diameter of 2.5 mm, 3 nails with a diameter of 3.4 mm and 3 nails with a diameter of 5 mm were then produced on one of the fitted and inflated tyres (250 kPa), through the tread and the crown block.

The tyres withstood being run on a rolling drum (diameter of 1707-2000 mm) at 80 km/h, under a nominal load of 536 kg, without loss in pressure for 200 km, after which distance running was halted.

After storing the tyres A and C for more than eight hours at ambient temperature, the nails were pulled out one by one at room temperature. For cold performance tests, the tyres B and D were stored in a climate chamber at −25 ° C. for more than eight hours.

Six of nine holes of tyre C and D were sealed after pulling out the nails. Surprisingly, eight of nine holes of tyre A and all (!) of the nine holes of tyre B were sealed after pulling out the nails clearly showing the superiority of the sealing compounds according to the invention.

What is claimed is:

1. A sealing composition comprising
(A) at least one crosslinked butyl rubber
(B) at least one resin
and none, one, two, three or all of the following components:
(C) at least one ageing stabilizer
(D) at least one rubber other than the crosslinked butyl rubbers according to (A)
(E) at least one plasticizer
(F) at least one filler.

2. The sealing composition according to claim 1 comprising the following three components selected from (C); (D); (E) and (F):
(C) at least one ageing stabilizer
(D) at least one rubber other than the crosslinked butyl rubbers according to (A)
(E) at least one plasticizer.

3. The sealing composition according to claim 1, wherein the at least one crosslinked butyl rubber is a copolymer comprising structural units derived from
a) at least one isoolefin
b) at least one conjugated multiolefin wherein the structural units derived from conjugated multiolefin may be either (i) at least partially halogenated or (ii) non-halogenated whereby the crosslinked butyl rubbers further have
(I) a Mooney viscosity of at least 30 measured according to ASTM D 1646, ML 1+8 at 125° C. and
(II) a gel content of a least 5 wt-%.

4. The sealing composition according to claim 3, wherein the structural units derived from at least one isoolefin include structural units of at least one isoolefin selected from the group consisting of isobutene, 2-methyl-1-butene, 3-methyl-1-butene, 2-methyl-2-butene, preferably isobutene.

5. The sealing composition according to claim 3, wherein the structural units derived from at least one conjugated multiolefin include structural units of at least one conjugated multiolefin selected from the group consisting of isoprene, butadiene, 2-methylbutadiene, 2,4-dimethylbutadiene, piperyline, 3-methyl-1, 3-pentadiene, 2,4-hexadiene, 2-neopentylbutadiene, 2-methyl-1, 5-hexadiene, 2,5-dimethyl-2, 4-hexadiene, 2-methyl-1,4-pentadiene, 4-butyl-1, 3-pentadiene, 2,3-dimethyl-1, 3-pentadiene, 2,3-dibutyl-1, 3-pentadiene, 2-ethyl-1, 3-pentadiene, 2-ethyl-1, 3-butadiene, 2-methyl-1, 6-heptadiene, cyclopentadiene, methylcyclopentadiene, cyclohexadiene, 1-vinyl-cyclohexadiene and 1-methylcycloheptene, preferably isoprene.

6. The sealing composition according to claim 3, wherein the at least one crosslinked butyl rubber further comprises structural units derived from c) at least one crosslinking multiolefin other than the conjugated multiolefins according to b).

7. The sealing composition according to claim 6, wherein the structural units derived from at least one crosslinking multiolefin include structural units of at least one crosslinking multiolefin selected from the group consisting of norbornadiene, 2-isopropenylnorbornene, 5-vinyl-2-norbornene, divinylbenzene, diisopropenyl-benzene, divinyltoluene, divinylxylene or C₁ to C₂₀ alkyl-substituted derivatives of the aforementioned compounds, preferably divinylbenzene, diisopropenylbenzene, divinyltoluene, divinylxylene or C₁ to C₂₀ alkyl substituted derivatives of the aforementioned compounds, and most preferably divinylbenzene and diisopropenylbenzene.

8. The sealing composition according to claim 1, wherein the total amount of crosslinked butyl rubber in the sealing compound is 45 phr to 100 phr, with the sum of crosslinked butyl rubber (A) and, where present, further rubbers (D) representing 100 phr.

9. The sealing composition according to claim 1,
wherein the resins include hydrocarbon resins, preferably those having at least one and optionally all of the following properties:
a glass transition temperature Tg of greater than −50° C.,
a softening point of greater than −30° C.,
a number-average molecular weight (Mn) of from 400 g/mol to 2000 g/mol, or
a polydispersity (PDI=Mw/Mn, with Mw=weight-average molecular weight) of less than 3.

10. The sealing composition according to claim 1, any one of claims 1 to 9, wherein the amount of resin (B) in the sealing compound of the invention is 10 phr to 60 phr, based on the sum of crosslinked butyl rubber and, where present further rubbers (D).

11. The sealing composition according to claim 1, comprising (D) at least one rubber other than the crosslinked butyl rubbers according to (A) selected from the group consisting of copolymers based on conjugated diolefins from a group comprising 1,3-butadiene, isoprene, 2,3-dimethyl-1,3-butadiene, 1,3-pentadiene, 1,3-hexadiene, 3-butyl-1,3-octadiene, 2-phenyl-1,3-butadiene or mixtures thereof.

12. The sealing composition according to claim 1, comprising
45 phr to 100 phr of at least one crosslinked butyl rubber
10 phr to 60 phr of at least one resin (B),
0 phr to 20 phr of at least one ageing stabilizer (C),
0 phr to 55 phr of at least one rubber (D),
0 phr to 60 phr of at least one plasticizer (E),
optionally 1 phr to 50 phr of at least one filler (F),
based in each case on the sum of crosslinked butyl rubber (A) and, where present, further rubbers (D).

13. A process for the preparation of the sealing compounds according to claim 1, the process comprising at least the step of mixing the solid or liquid components or solutions thereof.

14. A pneumatic vehicle tyre comprising a sealing compound according to claim 1.

15. A vehicle comprising at least one pneumatic vehicle tyre according to claim 14.
